(19) United States
(12) Patent Application Publication
(10) Pub. No.: US 2012/0269719 A1
(43) Pub. Date: Oct. 25, 2012

(54) LARGE CRYSTAL, ORGANIC-FREE CHABAZITE, METHODS OF MAKING AND USING THE SAME

(75) Inventors: Bjorn Moden, Glen Mills, PA (US); David Cooper, Morrisville, PA (US); Hong-Xin Li, Lansdale, PA (US); William E. Cormier, Harleysville, PA (US)

(73) Assignee: PQ CORPORATION, Valley Forge, PA (US)

(21) Appl. No.: 13/449,230

(22) Filed: Apr. 17, 2012

Related U.S. Application Data
(60) Provisional application No. 61/476,575, filed on Apr. 18, 2011.

(51) Int. Cl. C01B 39/02; B01D 53/56

(52) U.S. Cl. 423/709; 423/700; 423/239.2

(57) ABSTRACT

There is disclosed a method to synthesize microporous crystalline material comprising a metal containing chabazite having a crystal size greater than 0.5 microns and a silica-to-alumina ratio (SAR) between 5 and 15, wherein the method is carried out without the use of an organic structural directing agent and without requiring calcination. There is also disclosed a large crystal organic free chabazite made according to the disclosed method. In addition, there are disclosed methods of using the disclosed crystalline material, such as in the selective catalytic reduction of NOₓ in exhaust gases.

This application claims priority to U.S. Provisional Application No. 61/476,575, filed on Apr. 18, 2011, which is incorporated herein by reference in its entirety.

The present disclosure is related to a method of synthesizing large crystal chabazite that does not require organic structural directing agent. The present disclosure is also related hydrothermally stable microporous crystalline materials comprising a metal containing, organic-free chabazite, that is able to retain a certain percentage of its surface area and micropore volume after treatment with heat and moisture and features large crystal size. The present disclosure is also related to methods of using the disclosed large crystal chabazite materials, such as in reducing contaminants in exhaust gases. Such methods include the selective catalytic reduction (“SCR”) of exhaust gases contaminated with nitrogen oxides (“NOₓ”).

Microporous crystalline materials and their uses as catalysts and molecular sieve adsorbents are known in the art. Microporous crystalline materials include crystalline aluminosilicate zeolites, metal organosilicates, and aluminophosphates, among others. One catalytic use of the materials is in the SCR of NOₓ with ammonia in the presence of oxygen and in the conversion process of different feed stocks, such as an oxygenate to olefin reaction system.

Medium to large pore zeolites containing metals, such as ZSM-5 and Beta, are also known in the art for SCR of NOₓ using reductants, such as ammonia.

A class of silicon-substituted aluminophosphates, which are both crystalline and microporous and exhibit properties characteristic of both aluminosilicate zeolites and aluminophosphates, are known in the art and disclosed in U.S. Pat. No. 4,440,871. Silicoaluminophosphates (SAPOs) are synthetic materials having a three-dimensional microporous aluminophosphate crystalline framework with silicon incorporated therein. The framework structure consists of PO₂⁺, AlO₂⁻, and SiO₂ tetrahedral units. The empirical chemical composition on an anhydrous basis is:

mR:(SiₓAl_{y}P_{z})O₂

wherein, R represents at least one organic templating agent present in the intracrystalline pore system; m represents the moles of R present per mole of (SiₓAl_{y}P_{z})O₂ and has a value from zero to 0.3; and x, y, and z represent the mole fractions of silicon, aluminum, and phosphorous, respectively, present as tetrahedral oxides.

The teachings of the following U.S. patents and patent application Publications are incorporated herein by reference: U.S. Pat. No. 4,503,024; U.S. Pat. No. 4,503,023; U.S. Pat. No. 7,645,718; U.S. Pat. No. 7,601,662; U.S. Patent Application Publication 2010/0092362; U.S. Patent Application Publication 2009/0048095 A1; and International Applications: WO/2010/074040; WO 2010/054034; and WO 2010/043891.

U.S. Pat. No. 7,645,718, based on U.S. Patent Application Publication 2008/0241060, disclosed small crystal Cu-exchanged low-silica chabazite for NH₃-SCR applications (Comparable Example 1). These materials were found to be unstable during high-temperature hydrothermal aging such as at 700° C. for 16 hours.

The following reference, Fickel et al., in the Journal of Physical Chemistry C, 2011, which describes Cu-SSZ-13 made with 12 SAR, is also incorporated by reference herein.

Nothing in the prior art describes the benefits associated with a metal containing zeolite having a large crystal structure of organic-free chabazite (CHA), and certainly not with the improved hydrothermal stability properties disclosed herein. Thus, the present disclosure is directed to a metal-containing, large crystal structure of organic-free chabazite (CHA), and a method of making the same without the use of organic structural directing agents. Therefore, the disclosed method has the added benefit of not requiring an additional step of calcination.

### SUMMARY OF THE INVENTION

There is disclosed a microporous crystalline material comprising an aluminosilicate zeolite synthesized without the use of an organic structural directing agent, wherein the zeolite comprises a chabazite (CHA) structure having copper and/or iron, a silica-to-alumina ratio (SAR) ranging from 5 to 15, and a crystal size greater than 0.5 microns.

The Inventors have shown that the microporous crystalline material described herein retains at least 60% of surface area after exposure to 700° C. for 16 hours in the presence of up to 10 volume percent of water vapor.

In one embodiment, the microporous crystalline material described herein has a Cu/Al molar ratio of at least 0.08.

In another embodiment, the microporous crystalline material contains iron in an amount of at least 0.5 weight percent of the total weight of the material, such as in an amount ranging from 0.5 to 10.0 weight percent of the total weight of the material.

There is also disclosed a method of selective catalytic reduction (SCR) of NOx in exhaust gas, using the microporous crystalline material described herein. For example, the method may comprise: contacting exhaust gas with an article comprising a metal-containing CHA type zeolite synthesized without the use of an organic structural directing agent, the zeolite having a crystal size greater than 0.5 microns and a silica-to-alumina ratio (SAR) ranging from 5 and 15.

It is appreciated that the contacting step described above is performed in the presence of ammonia, urea or an ammonia generating compound.

In one embodiment, the metal comprises copper and/or iron which may be introduced by liquid-phase or solid ion-exchange or by direct-synthesis.

There is also disclosed a method of making a microporous crystalline material comprising a aluminosilicate zeolite having a CHA structure, a silica-to-alumina ratio (SAR) ranging from 5 to 15, and a crystal size greater than 0.5 microns.

In one embodiment, the method comprises: mixing sources of potassium, alumina, silica, water and optionally a chabazite seed material to form a gel, wherein the gel has potassium to silica (K/SiO₂) molar ratio of less than 0.5 and hydroxide to silica (OH/SiO₂) molar ratio less than 0.35; heating the gel in a vessel at a temperature ranging from 80° C. to 200° C. to form a crystalline large crystal chabazite product; ammonium-exchanging the product.

In another embodiment, the method further comprises adding zeolite crystallization seeds to the product prior to the heating step.

It is further appreciated that the SAR of the product may be increased by further treating the product with a hexafluorosilicate salt, such as ammonium hexafluorosilicate or hexafluorosilicic acid.

In one embodiment, the potassium source is chosen from potassium hydroxide or potassium silicate.

The alumina and at least a portion of the silica source are chosen from potassium-exchanged, proton-exchanged or ammonium-exchanged zeolite Y. In one embodiment, the zeolite Y has a SAR between 4 and 20.

Aside from the subject matter discussed above, the present disclosure includes a number of other exemplary features such as those explained hereinafter. It is to be understood that both the foregoing description and the following description are exemplary only.

### BRIEF DESCRIPTION OF THE DRAWINGS

The accompanying table and figures are incorporated in, and constitute a part of this specification.

Table 1 compares the surface area retention of Cu-Chabazite materials with varying SAR and CuO after steaming at 700° C. for 16 h in 10 percent water/air.

FIG. 1 compares SCR data over Cu-Chabazite materials with varying SAR and varying Cu-loading after steaming at 700° C. for 16 h in 10 percent water/air. Reaction conditions for NH₃-SCR of NOₓ:500 ppm NOₓ; NH₃/NO=1.0; 5 vol % O₂; 0.6% H₂O; balance N₂; space velocity=50,000 h⁻¹.

FIG. 2 is a scanning electron micrograph (SEM) of the chabazite material described in Example 1.

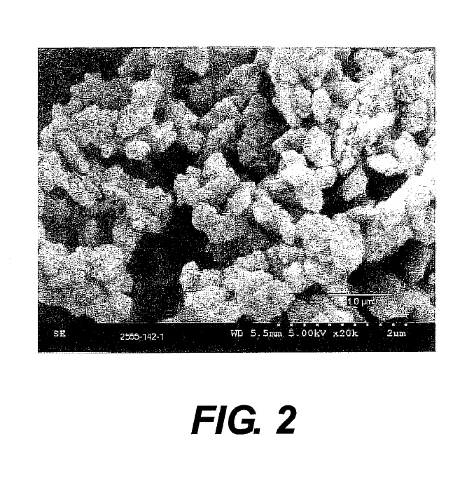

FIG. 3 is a scanning electron micrograph (SEM) of the chabazite material described in Example 2.

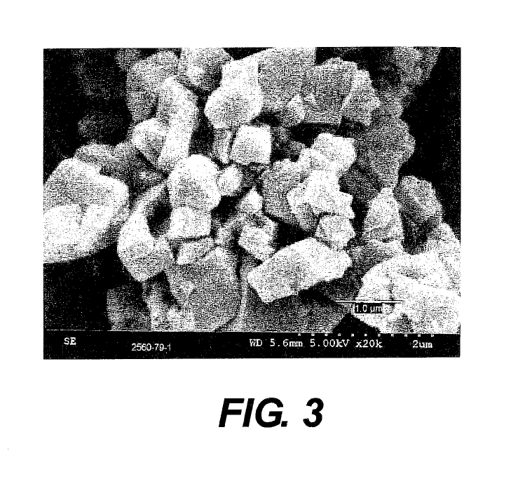

FIG. 4 is a scanning electron micrograph (SEM) of the chabazite material described in Example 3.

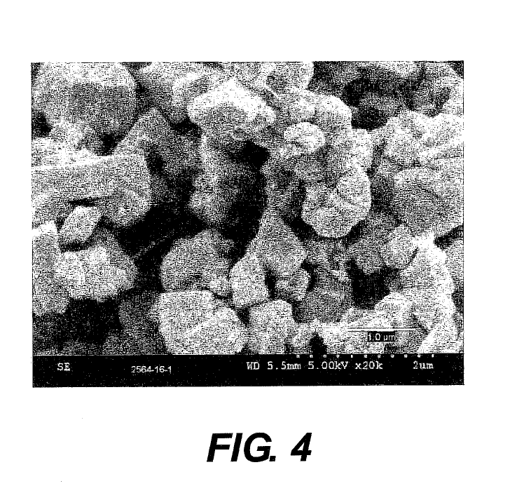

FIG. 5 is a scanning electron micrograph (SEM) of the chabazite material described in Example 4.

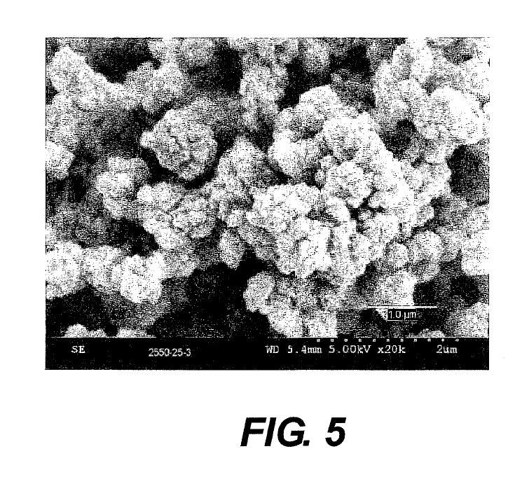

FIG. 6 is an X-ray diffraction pattern of the chabazite material described in Example 2.

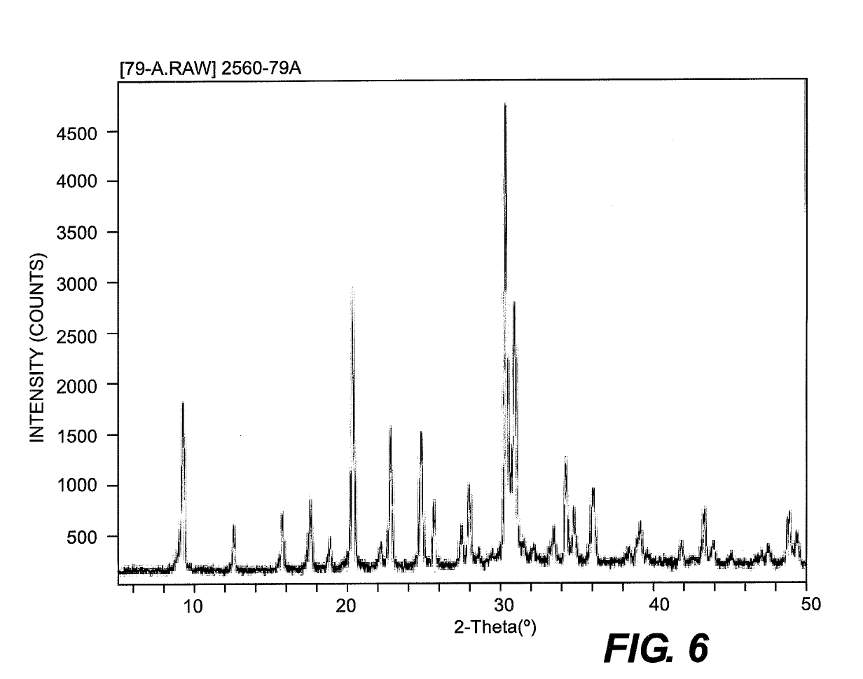

FIG. 7 is an X-ray diffraction pattern of the chabazite material described in Example 3.

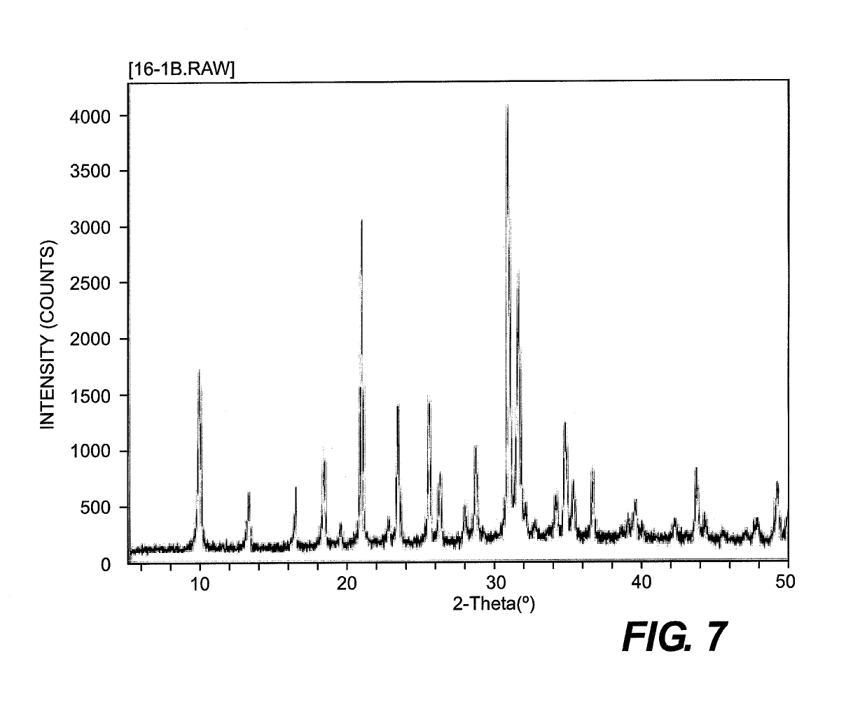

FIG. 8 is an X-ray diffraction pattern of the chabazite material described in Example 4.

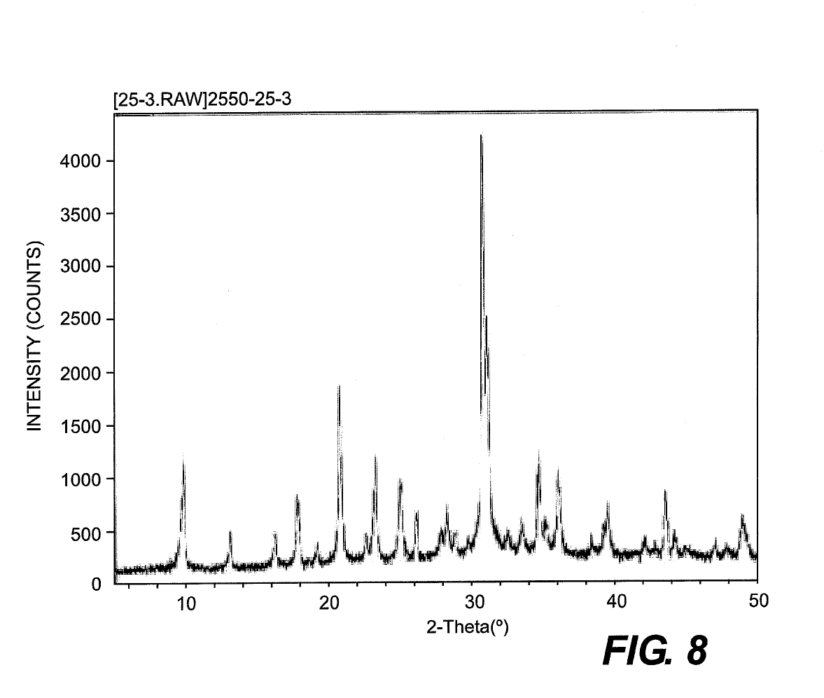

### DETAILED DESCRIPTION OF THE INVENTION

### Definitions

The following terms or phrases used in the present disclosure have the meanings outlined below:

“Hydrothermally stable” means having the ability to retain a certain percentage of initial surface area and/or microporous volume after exposure to elevated temperature and/or humidity conditions (compared to room temperature) for a certain period of time. For example, in one embodiment, it is intended to mean retaining at least 60%, such as at least 70%, or even at least 80%, of its surface area and micropore volume after exposure to conditions simulating those present in an automobile exhaust, such as temperatures ranging up to 700° C. in the presence of up to 10 volume percent (vol %) water vapor for times ranging from up to 1 hour, or even up to 16 hours, such as for a time ranging from 1 to 16 hours.

“Initial Surface Area” means the surface area of the freshly made crystalline material before exposing it to any aging conditions.

“Initial Micropore Volume” means the micropore volume of the freshly made crystalline material before exposing it to any aging conditions.

“Direct synthesis” (or any version thereof) refers to a method that does not require a metal-doping process after the zeolite has been formed, such as a subsequent ion-exchange or impregnation method.

“Defined by the Structure Commission of the International Zeolite Association,” is intended to mean those structures included but not limited to, the structures described in “Atlas of Zeolite Framework Types,” ed. Baerlocher et al., Sixth Revised Edition (Elsevier 2007), which is herein incorporated by reference in its entirety.

“Selective Catalytic Reduction” or “SCR” refers to the reduction of NOₓ (typically with ammonia, ammonia generating compound such as urea, or hydrocarbon) in the presence of oxygen to form nitrogen and H₂O. In other words, the reduction is catalyzed to preferentially promote the reduction of the NOₓ over the oxidation of ammonia by the oxygen, hence “selective catalytic reduction.”

“Exhaust gas” refers to any waste gas formed in an industrial process or operation and by internal combustion engines, such as from any form of motor vehicle. Non-limiting examples of the types of exhaust gases include both automotive exhaust, as well as exhaust from stationary sources, such as power plants, stationary diesel engines, and coal-fired plants.

The phrases “chosen from” or “selected from” as used herein refers to selection of individual components or the combination of two (or more) components. For example, the metal portion of the large crystal, organic-free chabazite described herein may be chosen from copper and iron, which means the metal may comprise copper, or iron, or a combination of copper and iron.

Regardless of the metal, it can be introduced into the chabazite in various ways, such as by liquid-phase or solid ion-exchange or incorporated by direct-synthesis. In one embodiment, the copper comprises at least 1.0 weight percent of the total weight of the material, such as a range from 1.0-15.0 weight percent of the total weight of the material.

As stated, the metal portion of the large crystal, organic-free chabazite may comprise iron instead of or in addition to copper. In one embodiment, the iron comprises at least 0.5 weight percent of the total weight of the material, such as an amount ranging from 0.5-10.0 weight percent of the total weight of the material.

While the nitrogen oxides of exhaust gases are commonly NO and NO₂, the present invention is directed to reduction of the class of nitrogen oxides identified as NOₓ. There is also disclosed a method of selective catalytic reduction (SCR) of these NOx in exhaust gas. In one embodiment, the method comprises contacting, typically in the presence of ammonia or urea, exhaust gas with a metal containing large crystal, organic-free chabazite as described herein. For example, the method comprises contacting exhaust gas with a metal containing chabazite having a crystal size greater than 0.5 microns and a silica-to-alumina ratio (SAR) ranging from 5 to 15. As mentioned, the metal containing large crystal, organic-free chabazite typically retains at least 60% and even 80% of its initial surface area and micropore volume after exposure to temperatures of up to 700° C. in the presence of up to 10 volume percent water vapor for up to 16 hours.

In one embodiment, the inventive method for SCR of exhaust gases may comprise (1) adding ammonia or urea to the exhaust gas to form a gas mixture; and (2) contacting the gas mixture with a microporous crystalline composition comprising large crystal, organic-free chabazite, having a crystal size larger than 0.5 microns, and SAR ranging from 5 to 15.

It has been found that such methods result in the substantial conversion of NOₓ and ammonia of the gas mixture to nitrogen and water. The microporous crystalline materials described herein show surprisingly high stability and high reduction of NOₓ activity.

The microporous crystalline materials of the present invention, including large crystal, organic-free chabazite, may also be useful in the conversion of oxygenate-containing feedstock into one or more olefins in a reactor system. In particular, the compositions may be used to convert methanol to olefins.

There is also disclosed a method of making the crystalline material according to the present disclosure. In one embodiment, this includes mixing sources of a potassium salt, a zeolite Y, water and optionally a chabazite seed material to form a gel; heating the gel in a vessel at a temperature ranging from 90° C. to 180° C. to form a crystalline large crystal, organic-free chabazite product; ammonium-exchanging the product.

In another embodiment, the method may comprise adding zeolite crystallization seeds to the product prior to the heating step. In another embodiment, the method further comprises a step of treating the product with a hexafluorosilicate salt, such as ammonium hexafluorosilicate (AFS) to increase the SAR of the product.

The present disclosure is also directed to a catalyst composition comprising the large crystal, organic-free chabazite material described herein. The catalyst composition may also be cation-exchanged, such as with iron or copper.

Any suitable physical form of the catalyst may be utilized, including, but not limited to: a channeled or honeycombed-type body; a packed bed of balls, pebbles, pellets, tablets, extrudates or other particles; microspheres; and structural pieces, such as plates or tubes.

It is appreciated that the channeled or honeycombed-shaped body or structural piece is formed by extruding a mixture comprising the chabazite molecular sieve.

In another embodiment, the channeled or honeycombed-shaped body or structural piece is formed by coating or depositing a mixture comprising the chabazite molecular sieve on a preformed substrate.

The invention will be further clarified by the following non-limiting examples, which are intended to be purely exemplary of the invention.

### EXAMPLES

### Example 1

### Chabazite as Seed Material

Deionized water, potassium hydroxide solution (45 wt % KOH) and calcined H-form zeolite Y powder were mixed together to form a gel with the following composition: 5.2 SiO₂:1.0 Al₂O₃:1.4 K₂O:104 H₂O.

The gel was stirred at room temperature for about 30 min before adding about 1.5 wt % of a chabazite seed and stirring for another 30 min. The gel was then charged to an autoclave. The autoclave was heated to 130° C. and maintained at the temperature for 24 hours while stirring at 300 rpm. After cooling, the product was recovered by filtration and washed with deionized water. The resulting product had the XRD pattern of chabazite.

### Example 2

### Large Crystal Chabazite Synthesized from H—Y

Deionized water, potassium hydroxide solution (45 wt % KOH) and calcined H-form zeolite Y powder were mixed together to form a gel with the following composition: 5.2 SiO₂:1.0 Al₂O₃:0.78 K₂O:104 H₂O.

The gel was stirred at room temperature for about 30 min before adding 1.5 wt % of a chabazite seed (product from Example 1) and stirring for another 30 min. The gel was then charged to an autoclave. The autoclave was heated to 140° C. and maintained at the temperature for 30 hours while stirring at 300 rpm. After cooling, the product was recovered by filtration and washed with deionized water. The resulting product had the XRD pattern of chabazite, a silica-to-alumina ratio (SAR) of 5.5 and contained 17.0 wt % K₂O.

### Example 3

### Large Crystal Chabazite Synthesized from K—Y

Deionized water, potassium hydroxide solution (45 wt % KOH) and potassium-exchanged zeolite Y powder were mixed together to form a gel with the following composition: 5.5 SiO₂:1.0 Al₂O₃:1.09 K₂O:82 H₂O.

The gel was stirred at room temperature for about 30 min before adding 1.5 wt % of a chabazite seed (product from Example 1) and stirring for another 30 min. The gel was then charged to an autoclave. The autoclave was heated to 160° C. and maintained at the temperature for 48 hours while stirring at 300 rpm. After cooling, the product was recovered by filtration and washed with deionized water. The resulting product had the XRD pattern of chabazite, an SAR of 5.5 and contained 16.9 wt % K₂O.

### Comparable Example 4

### Small Crystal Chabazite

Deionized water, potassium hydroxide solution (45 wt % KOH) and calcined H-form zeolite Y powder were mixed together to form a gel with the following composition: 5.2 SiO₂:1.0 Al₂O₃:2.07 K₂O:233 H₂O.

The gel was stirred at room temperature for about 30 min before charging the gel to an autoclave. The autoclave was heated to 95° C. and maintained at the temperature for 72 hours while stirring at 50 rpm. After cooling, the product was recovered by filtration and washed with deionized water. The resulting product had the XRD pattern of chabazite, an SAR of 4.6 and contained 19.6 wt % K₂O.

### Comparable Example 5

### Small Crystal Chabazite

Low-silica chabazite (structure code CHA) was synthesized according to examples of U.S. Pat. No. 5,026,532, which is herein incorporated by reference. After filtering, washing, and drying, the product was calcined at 550° C. To remove residual sodium and potassium, the product was then washed in a solution containing 0.25 M HNO3 and 4 M NH4NO3 at 80° C. for 2 hours.

### Example 6

### NH4-Exchange and AFS-Treatment of Example 2

The product from Example 2 was exchanged with ammonium nitrate twice to reduce the potassium content to 3.2 wt % K₂O.

The NH4-exchanged material was treated with ammonium hexafluorosilicate in order to increase the SAR. 12 g on an anhydrous basis of the NH4-exchanged material was slurried in 100 g deionized water and heated to 75° C. An ammonium hexafluorosilicate solution was made by dissolving 2.3 g ammonium hexafluorosilicate in 400 g deionized water. The ammonium hexafluorosilicate solution was added to the chabazite slurry over a period of 3 hours while stirring. After 3 hours, 25 g deionized water was added. Following the water addition, a solution of 7.8 g Al₂(SO₄)₃-18 H₂O in 100 g deionized water was added to the slurry. After 15 minutes, the product was recovered by filtration and washed with deionized water. The resulting product had an SAR of 7.3 and contained 2.3 wt % K₂O. This material was further ammonium-exchanged twice to reach 0.24 wt % K₂O.

### Example 7

### NH4-Exchange and Calcination of Example 2

The product from Example 2 was exchanged with ammonium nitrate twice to reduce the potassium content to 3.2 wt % K₂O. This material was then calcined at 540° C. for 4 hours. Following the calcination, the material was exchanged with ammonium nitrate twice resulting in a potassium content of 0.06 wt % K₂O.

### Comparable Example 8

### NH4-Exchange and AFS-Treatment of Comparable Example 4

The product from Comparable Example 4 was exchanged with ammonium nitrate twice. The NH4-exchanged material was treated with ammonium hexafluorosilicate in order to increase the SAR. 24 g on an anhydrous basis of the NH4-exchanged material was slurried in 200 g deionized water and heated to 75° C. An ammonium hexafluorosilicate solution was made by dissolving 3.5 g ammonium hexafluorosilicate in 600 g deionized water. The ammonium hexafluorosilicate solution was added to the chabazite slurry over a period of 3 hours while stirring. After 3 hours, 25 g deionized water was added. Following the water addition, a solution of 11.9 g Al₂(SO₄)₃-18 H₂O in 150 g deionized water was added to the slurry. After 15 minutes, the product was recovered by filtration and washed with deionized water. The resulting product had an SAR of 6.0 and contained 2.6 wt % K₂O. This material was further ammonium-exchanged twice.

### Copper Exchange

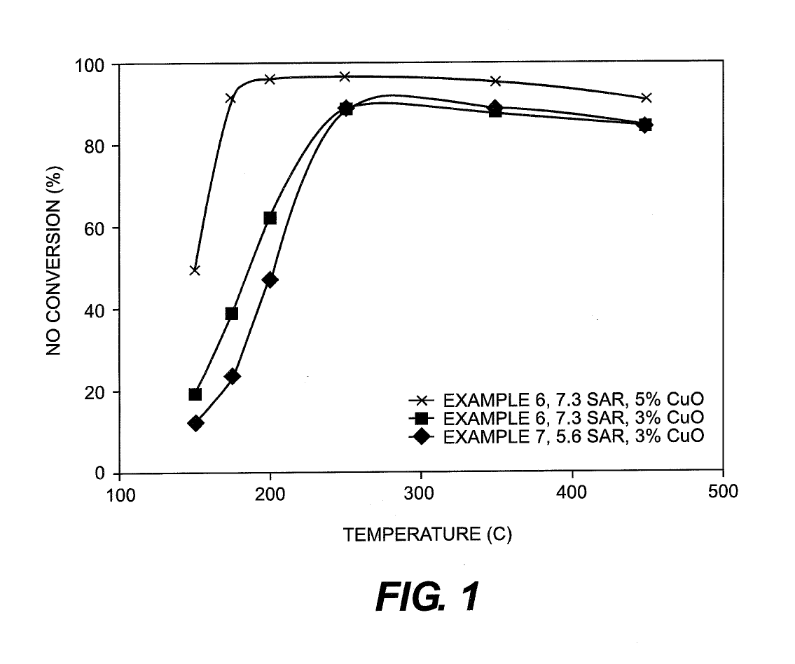

Samples from examples 5, 6, 7 and 8 were Cu-exchanged to obtain 2, 3 and/or 5% CuO. These samples were further hydrothermally aged and tested for their surface area retention and NH₃-SCR activity (Table 1, FIG. 1).

### Steam Treatment

The foregoing samples were steamed at 700° C. in the presence of 10 vol % water vapor for 16 hours to simulate automotive exhaust aging conditions. The surface areas before and after aging are shown in Table 1. The activities of the hydrothermally aged materials for NOx conversion, using NH₃ as reductant, were tested with a flow-through type reactor. Powder zeolite samples were pressed and sieved to 35/70 mesh and loaded into a quartz tube reactor. Reactor temperature was ramped and NOx conversion was determined with an infrared analyzer at each temperature interval. The gas stream conditions and SCR results are set forth in FIG. 1 below.

TABLE 1

| | | | Initial | Surface area | |
|---|---|---|---|---|---|
| | | Cu/Al | surface | after steaming | Surface |
| | CuO | molar | area | at 700° C. | area |
| Example | (Wt %) | ratio | (m²/g) | (m²/g) | retention % |
| 5 | 2.0 | 0.062 | 557 | 10 | 1.8 |
| 6 | 3.0 | 0.104 | 633 | 508 | 80.3 |
| 6 | 5.0 | 0.178 | 608 | 498 | 81.9 |
| 7 | 3.0 | 0.085 | 592 | 391 | 66.0 |
| 8 | 3.0 | 0.088 | 511 | 149 | 29.2 |
| 8 | 5.0 | 0.146 | 497 | 280 | 56.3 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with the true scope of the invention being indicated by the following claims.

What we claim is:

1. A microporous crystalline material comprising an aluminosilicate zeolite synthesized without the use of an organic structural directing agent, wherein said zeolite comprises a chabazite (CHA) structure having copper and/or iron, a silica-to-alumina ratio (SAR) ranging from 5 to 15, and a crystal size greater than 0.5 microns.

2. A microporous crystalline material of claim 1, wherein said copper and/or iron is introduced by liquid-phase or solid ion-exchange or incorporated by direct-synthesis.

3. A microporous crystalline material of claim 2, wherein the Cu/Al molar ratio is at least 0.08.

4. A microporous crystalline material of claim 1, wherein said copper and/or iron containing chabazite retains at least 60% of surface area after exposure to 700° C. for 16 hours in the presence of up to 10 volume percent of water vapor.

5. A microporous crystalline material of claim 2, wherein said iron comprises at least 0.5 weight percent of the total weight of said material.

6. A microporous crystalline material of claim 5, wherein said iron comprises an amount ranging from 0.5 to 10.0 weight percent of the total weight of said material.

7. A method of selective catalytic reduction (SCR) of NOx in exhaust gas, said method comprising:
contacting exhaust gas with an article comprising a metal-containing CHA type zeolite synthesized without the use of an organic structural directing agent, said zeolite having a crystal size greater than 0.5 microns and a silica-to-alumina ratio (SAR) between 5 and 15.

8. The method of claim 7, wherein said contacting step is performed in the presence of ammonia, urea or an ammonia generating compound.

9. The method of claim 7, wherein said metal comprises copper and/or iron.

10. The method of claim 9, wherein said copper or iron is introduced by liquid-phase or solid ion-exchange or incorporated by direct-synthesis.

11. The method of claim 9, wherein said copper comprises Cu/Al molar ratio at least 0.08.

12. The method of claim 9, wherein said iron comprises at least 0.5 weight percent of the total weight of said material.

13. The method of claim 12, wherein said iron comprises an amount ranging from 0.5 to 10.0 weight percent of the total weight of said material.

14. A method of making a microporous crystalline material comprising a aluminosilicate zeolite having a CHA structure, a silica-to-alumina ratio (SAR) ranging from 5 to 15, and a crystal size greater than 0.5 microns; said method comprising mixing sources of potassium, alumina, silica, water and optionally a chabazite seed material to form a gel, wherein said gel has potassium to silica (K/SiO₂) molar ratio of less than 0.5 and hydroxide to silica (OH/SiO₂) molar ratio less than 0.35; heating said gel in a vessel at a temperature ranging from 80° C. to 200° C. to form a crystalline large crystal chabazite product; ammonium-exchanging said product.

15. The method of claim 14, further comprising adding zeolite crystallization seeds to said product prior to said heating step.

16. The method of claim 14 further treating said product with a hexafluorosilicate salt to increase the SAR of the product.

17. The method of claim 14, wherein said potassium source is chosen from potassium hydroxide, potassium silicate, potassium-containing zeolites or mixtures thereof.

18. The method of claim 14, wherein said alumina and silica sources are chosen from potassium-exchanged, proton-exchanged, ammonium-exchanged zeolite Y, potassium silicate or mixtures thereof.

19. The method of claim 18, wherein said zeolite Y has a SAR between 4 and 20.

20. The method of claims 16, wherein said hexafluorosilicate treatment consists of contacting the large-crystal chabazite zeolite with a hexafluorosilicate salt.

21. The method of claim 20 wherein said hexafluorosilicate salt is chosen from ammonium hexafluorosilicate or hexafluorosilicic acid.

22. The method of claim 7, wherein said article is in the form of a channeled or honeycombed-shaped body; a packed bed; microspheres; or structural pieces.

23. The method of claim 22, wherein said packed bed comprises balls, pebbles, pellets, tablets, extrudates, other particles, or combinations thereof.

24. The method of claim 22, where said structural pieces are in the form of plates or tubes.

25. The method of claim 22, wherein the channeled or honeycombed-shaped body or structural piece is formed by extruding a mixture comprising the chabazite zeolite.

26. The method of claim 22, wherein the channeled or honeycombed-shaped body or structural piece is formed by coating or depositing a mixture comprising the chabazite zeolite on a preformed substrate.
